(19) United States
(12) Patent Application Publication
(10) Pub. No.: US 2005/0040260 A1
(43) Pub. Date: Feb. 24, 2005

(54) Coaxial low pressure injection method and a gas collimator for a kinetic spray nozzle

(76) Inventors: Zhibo Zhao, Ann Arbor, MI (US); Bryan A. Gillispie, Warren, MI (US); Taeyoung Han, Bloomfield Hills, MI (US); John R. Smith, Birmingham, MI (US); Brian K. Fuller, Rochester Hills, MI (US)

Correspondence Address: SCOTT A. MCBAIN;DELPHI TECHNOLOGIES, INC., Mail Code: 480-410-202, P.O. Box 5052, Troy, MI, 48007-5052, US

(21) Appl. No.: 10/646,551

(22) Filed: Aug. 21, 2003

(51) Int. Cl. B05B 7/06; B05B 1/14; A62C 2/08

(52) U.S. Cl. 239/548; 239/558; 239/553.3

(57) ABSTRACT

A new gas collimator for use in a kinetic spray system is disclosed. The collimator reduces turbulence of the main gas and results in significant increases in the amount of particles deposited on a substrate using the system. Kinetic spray nozzles incorporating the new collimator also have significantly higher deposition efficiencies. The new collimator enables the main gas temperature to be reduced while permitting much higher depositions and deposition efficiencies compared to the prior art collimator. Also disclosed is a low pressure injection method for a kinetic spray system. The coaxial, low pressure injection method enables the use of low pressure powder feeders, which are low cost, technologically mature, and widely available commercially. The coaxial injection method overcomes several undesirable effects associated with prior art high pressure injection methods.

### TECHNICAL FIELD

The present invention is directed toward a design for a gas collimator, and more particularly, toward a gas collimator for a kinetic spray nozzle and a low pressure injection method.

### INCORPORATION BY REFERENCE

The present invention comprises an improvement to the kinetic spray process as generally described in U.S. Pat. Nos. 6,139,913, 6,283,386 and the articles by Van Steenkiste, et al. entitled “Kinetic Spray Coatings” published in Surface and Coatings Technology Volume III, Pages 62-72, Jan. 10, 1999, and “Aluminum coatings via kinetic spray with relatively large powder particles”, published in Surface and Coatings Technology 154, pp. 237-252, 2002, all of which are herein incorporated by reference.

### BACKGROUND OF THE INVENTION

A new technique for producing coatings on a wide variety of substrate surfaces by kinetic spray, or cold gas dynamic spray, was recently reported in two articles by T. H. Van Steenkiste et al. The first was entitled “Kinetic Spray Coatings,” published in Surface and Coatings Technology, vol. 111, pages 62-71, Jan. 10, 1999 and the second was entitled “Aluminum coatings via kinetic spray with relatively large powder particles”, published in Surface and Coatings Technology 154, pp. 237-252, 2002. The articles discuss producing continuous layer coatings having high adhesion, low oxide content and low thermal stress. The articles describe coatings being produced by entraining metal powders in an accelerated gas stream, through a converging-diverging de Laval type nozzle and projecting them against a target substrate. The particles are accelerated in the high velocity gas stream by the drag effect. The gas used can be any of a variety of gases including air, nitrogen or helium. It was found that the particles that formed the coating did not melt or thermally soften prior to impingement onto the substrate. It is theorized that the particles adhere to the substrate when their kinetic energy is converted to a sufficient level of thermal and mechanical deformation. Thus, it is believed that the particle velocity must exceed a critical velocity to permit it to adhere when it strikes the substrate. It was found that the deposition efficiency of a given particle mixture was increased as the main gas temperature was increased. Increasing the main gas temperature decreases its density and thus increases its velocity. The velocity varies approximately as the square root of the main gas temperature. The actual mechanism of bonding of the particles to the substrate surface is not fully known at this time. The critical velocity is dependent on the material of the particle and of the substrate. Once an initial layer of particles has been formed on a substrate subsequent particles not only eliminate the voids between previous particles bound to the substrate by compaction, but also engage in particle to particle bonds. The bonding process is not due to melting of the particles in the main gas stream because the temperature of the particles is always below their melting temperature.

The above kinetic spray methods all relied on high pressure particle powder feeders. These powder feeders are very expensive and can cause erosion of the throat of the kinetic spray nozzle. In addition, high pressure systems are prone to clogging at the throat of the nozzle, which limits the main gas temperatures that can be used.

A recent improvement was disclosed in U.S. application Ser. No. 10/117,385, filed Apr. 5, 2002. In this improvement the particle powder is introduced through the side of the nozzle in the diverging section, which allows a low pressure powder feeder to be used. Low pressure powder feeders are very common, inexpensive and reliable. This method suffers from erosion of the nozzle sidewall opposite the point of powder introduction, especially when hard materials are sprayed. In some cases, the edges of the spray path produced by this method are saw-toothed and not clean well defined edges such as are obtained using the prior art high pressure method described above. The reason for this appears to be asymmetric assimilation of the particles into the gas stream. Both the high pressure and the low pressure prior art systems suffer from turbulence in the entraining main gas associated with high velocity flow, especially when the main gas goes through a right angle as it is introduced into the converging section of the nozzle. Turbulence significantly reduces the deposition efficiency of the kinetic spray system. Thus, the kinetic spray process requires higher main gas temperatures to obtain efficient deposition of particles.

### SUMMARY OF THE INVENTION

In one embodiment, the present invention is a gas collimator for a kinetic spray nozzle comprising a collimator having a central hole surrounded by a plurality of gas flow holes and a length of from 10 to 30 millimeters with the gas flow holes having a hydraulic diameter of from 0.5 to 5.0 millimeters.

In another embodiment, the present invention is a kinetic spray nozzle comprising a supersonic nozzle having a gas collimator located between a premix chamber and a mixing chamber; the mixing chamber located adjacent to a converging section of the nozzle; a throat located between the converging section and a diverging section of the nozzle; the collimator having a central hole surrounded by a plurality of gas flow holes and a length of from 10 to 30 millimeters; and the gas flow holes having a hydraulic diameter of from 0.5 to 5.0 millimeters.

In another embodiment, the present invention is a method of applying a material via a kinetic spray process comprising the steps of providing a particle powder; providing a converging diverging supersonic nozzle having a gas collimator having a central hole surrounded by a plurality of gas flow holes and a length of from 10 to 30 millimeters; the gas flow holes having a hydraulic diameter of from 0.5 to 5.0 millimeters; directing a flow of a gas through the collimator and the nozzle, the gas having a temperature insufficient to cause melting of the particles in the nozzle; and entraining the particles in the flow of the gas and accelerating the particles to a velocity sufficient to cause the particles to adhere to a substrate positioned opposite the nozzle.

### BRIEF DESCRIPTION OF THE DRAWINGS

The present invention will now be described, by way of example, with reference to the accompanying drawings, in which like parts throughout the views have the same reference number:

FIG. 1 is a general schematic layout illustrating a kinetic spray system for performing the method of the present invention;

FIG. 2 is an enlarged cross-sectional view of a prior art kinetic spray nozzle used with a high pressure powder feeder in a kinetic spray system;

FIG. 3 is an enlarged cross-sectional view of a prior art kinetic spray nozzle used with a low pressure powder feeder in a kinetic spray system;

FIG. 4 is an enlarged cross-sectional view of a kinetic spray nozzle of the present invention used with a high pressure powder feeder in the kinetic spray system;

FIG. 5 is an enlarged cross-sectional view of a kinetic spray nozzle of the present invention used with a low pressure powder feeder in the kinetic spray system;

FIG. 6 is a graph showing the pressure at the end of an injector in a kinetic spray nozzle of the present invention used with a low pressure powder feeder in the system versus the main gas temperature;

FIG. 7 is a graph comparing the deposition efficiency of the nozzles shown in FIGS. 2, 3, and 5;

FIG. 8A is an end view of a prior art gas collimator;

FIG. 8B is an end view of a gas collimator designed according to the present invention;

FIG. 9A is a graph comparing the loading of a substrate by a nozzle having a prior art gas collimator versus a nozzle having a gas collimator designed according to the present invention; and

FIG. 9B is a graph comparing the deposition efficiency of a nozzle having a prior art gas collimator versus a nozzle having a gas collimator designed according to the present invention.

### DESCRIPTION OF THE PREFERRED EMBODIMENT

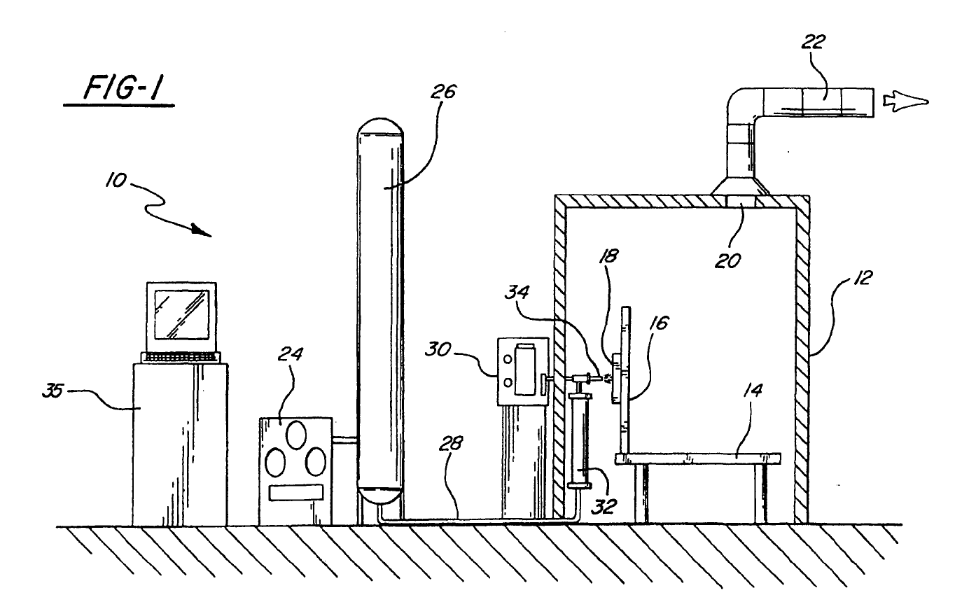

Referring first to FIG. 1, a kinetic spray system according to the present invention is generally shown at 10. System 10 includes an enclosure 12 in which a support table 14 or other support means is located. A mounting panel 16 fixed to the table 14 supports a work holder 18 capable of movement in three dimensions and able to support a suitable workpiece formed of a substrate to be coated. The work holder 18 is preferably designed to move a substrate relative to a nozzle 34 of the system 10, thereby controlling where the powder material is deposited on the substrate. In other embodiments the work holder 18 is capable of feeding a substrate past the nozzle 34 at traverse rates of up to 50 inches per second. The enclosure 12 includes surrounding walls having at least one air inlet, not shown, and an air outlet 20 connected by a suitable exhaust conduit 22 to a dust collector, not shown. During coating operations, the dust collector continually draws air from the enclosure 12 and collects any dust or particles contained in the exhaust air for subsequent disposal.

The spray system 10 further includes an air compressor 24 capable of supplying air pressure up to 3.4 MPa (500 pounds per square inch) to a high pressure air ballast tank 26. The air ballast tank 26 is connected through a line 28 to both a powder feeder 30 and a separate air heater 32. The air heater 32 supplies high pressure heated air, the main gas described below, to a kinetic spray nozzle 34. The pressure of the main gas generally is set at from 150 to 500 pounds per square inch (psi), more preferably from 300 to 400 psi. The powder feeder 30 is either a high pressure powder feeder or a low pressure powder feeder depending on the design of the nozzle 34 as described below. When the powder feeder 30 is a high pressure feeder 30 preferably the pressure is set at a pressure of from 25 to 100 psi, and more preferably from 25 to 50 psi above the pressure of the main gas. When the powder feeder 30 is a low pressure feeder the pressure is preferably from 60 to 125 psi, more preferably from 60 to 100 psi, even more preferably from 60 to 90 psi, and most preferably from 70 to 80 psi. The powder feeder 30 mixes particles of a spray powder with the high or low pressure air and supplies the mixture to a supplemental inlet line 48 of the nozzle 34. Preferably the particles are fed at a rate of from 20 to 1200 grams per minute, more preferably from 60 to 600 grams per minute to the nozzle 34. A computer control 35 operates to control the powder feeder 30, the pressure of air supplied to the powder feeder 30, the pressure of air supplied to the air heater 32 and the temperature of the heated main gas exiting the air heater 32.

The particles used in the present invention may comprise any of the materials disclosed in U.S. Pat. Nos. 6,139,913 and 6,283,386 in addition to other known particles. These particles generally comprise metals, alloys, ceramics, polymers, diamonds and mixtures of these. The particles preferably have an average nominal diameter of from 60 to 110 microns, more preferably from 63 to 106 microns, and most preferably from 63 to 90 microns. The substrate materials useful in the present invention may be comprised of any of a wide variety of materials including a metal, an alloy, a semi-conductor, a ceramic, a plastic, and mixtures of these materials. All of these substrates can be coated by the process of the present invention.

Depending on the particles or combination of particles chosen the main gas temperature may range from 600 to 1200 degrees Fahrenheit. The main gas has a temperature that is always insufficient to cause melting within the nozzle 34 of any particles being sprayed. For the present invention it is preferred that the main gas temperature range from 600 to 1200 degrees Fahrenheit depending on the material that is sprayed. What is necessary is that the temperature and exposure time of the particles to the main gas be selected such that the particles do not melt in the nozzle 34. The temperature of the gas rapidly falls as it travels through the nozzle 34. In fact, the temperature of the gas measured as it exits the nozzle 34 is often at or below room temperature even when its initial inlet temperature is above 1000° F.

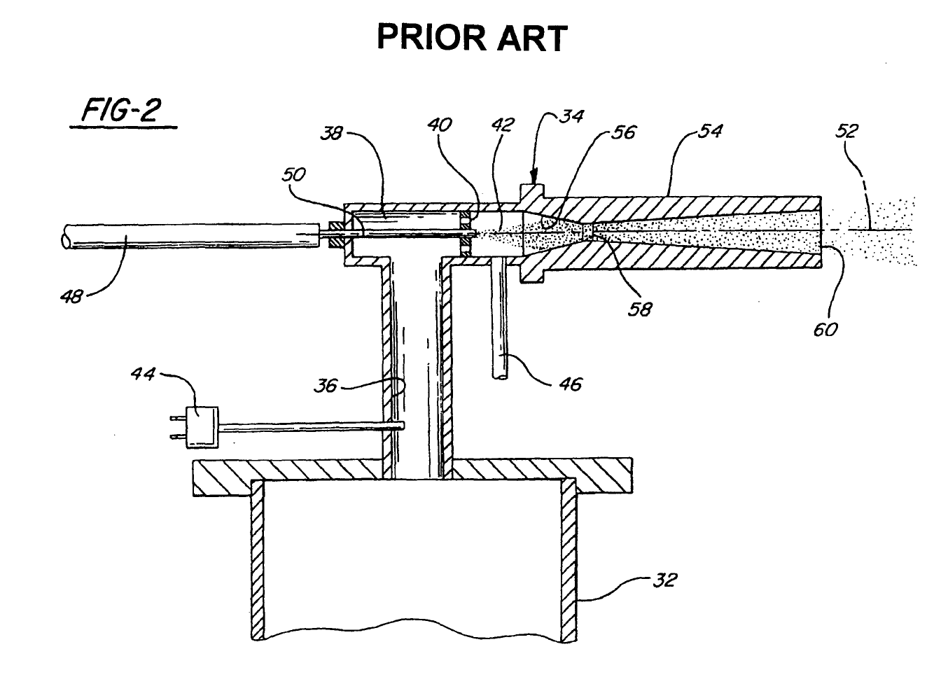

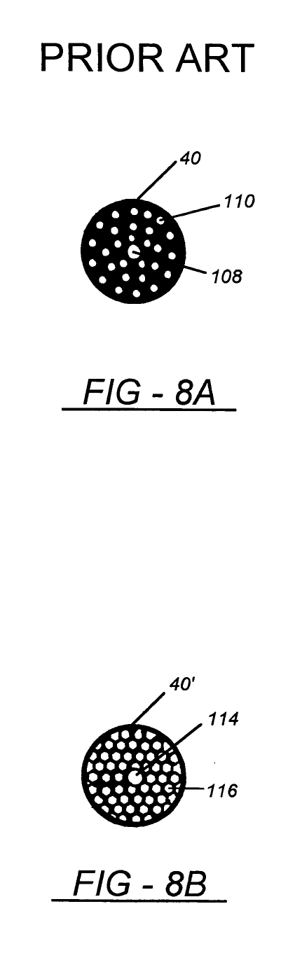

FIG. 2 is a cross-sectional view of a prior art nozzle 34 and its connections to the air heater 32 and a high pressure powder feeder 30. This nozzle 34 has been used in a high pressure system. A main air passage 36 connects the air heater 32 to the nozzle 34. Passage 36 connects with a premix chamber 38 that directs air through a gas collimator 40 and into a chamber 42. This prior art gas collimator 40 is a disc approximately 1 millimeter in thickness, see FIG. 8A for an end view. The collimator 40 includes a central injector hole 108 for receiving a powder injector tube 50. A series of gas flow holes 110 surround the injector hole 108. Temperature and pressure of the air or other heated main gas are monitored by a gas inlet temperature thermocouple 44 in the passage 36 and a pressure sensor 46 connected to the chamber 42.

The mixture of high pressure air and coating powder is fed through the supplemental inlet line 48 to the powder injector tube 50 comprising a straight pipe having a predetermined inner diameter. The tube 50 has a central axis 52 which is preferentially the same as the axis of the premix chamber 38. The tube 50 extends through the premix chamber 38 and the flow straightener 40 into the mixing chamber 42.

Chamber 42 is in communication with a de Laval type supersonic nozzle 54. The nozzle 54 has a central axis 52 and an entrance cone 56 that decreases in diameter to a throat 58. The entrance cone 56 forms a converging region of the nozzle 54. Downstream of the throat 58 is an exit end 60 and a diverging region is defined between the throat 58 and the exit end 60. The largest diameter of the entrance cone 56 may range from 10 to 6 millimeters, with 7.5 millimeters being preferred. The entrance cone 56 narrows to the throat 58. The throat 58 may have a diameter of from 5.5 to 1.5 millimeters, with from 4.5 to 2 millimeters being preferred. The diverging region of the nozzle 54 from downstream of the throat 58 to the exit end 60 may have a variety of shapes, but in a preferred embodiment it has a rectangular cross-sectional shape. At the exit end 60 the nozzle 54 preferably has a rectangular shape with a long dimension of from 8 to 14 millimeters by a short dimension of from 2 to 6 millimeters.

As disclosed in U.S. Pat. Nos. 6,139,913 and 6,283,386 the powder injector tube 50 supplies a particle powder mixture to the system 10 under a pressure in excess of the pressure of the heated main gas from the passage 36. The nozzle 54 produces an exit velocity of the entrained particles of from 300 meters per second to as high as 1200 meters per second. The entrained particles gain kinetic and thermal energy during their flow through this nozzle 54. It will be recognized by those of skill in the art that the temperature of the particles in the gas stream will vary depending on the particle size and the main gas temperature. The main gas temperature is defined as the temperature of heated high-pressure gas at the inlet to the nozzle 54. Since the particles are never heated to their melting point, even upon impact, there is no change in the solid phase of the original particles due to transfer of kinetic and thermal energy, and therefore no change in their original physical properties. The particles are always at a temperature below the main gas temperature. The particles exiting the nozzle 54 are directed toward a surface of a substrate to be coated.

It is preferred that the exit end 60 of the nozzle 54 have a standoff distance from the surface to be coated of from 10 to 80 millimeters and most preferably from 10 to 20 millimeters. Upon striking a substrate opposite the nozzle 54 the particles flatten into a nub-like structure with an aspect ratio of generally about 5 to 1. Upon impact the kinetic sprayed particles stick to the substrate surface if their critical velocity has been exceeded. For a given particle to adhere to a substrate it is necessary that it reach or exceed its critical velocity which is defined as the velocity where at it will adhere to a substrate, because the kinetic energy of the particles must be converted to thermal and strain energies via plastic deformation upon impact. This critical velocity is dependent on the material composition of the particle and the type of substrate material. In general, harder materials must achieve a higher velocity before they adhere to a given substrate. The nature of the bonds between kinetically sprayed particles and the substrate is discussed in the article in Surface and Coatings Technology 154, pp. 237-252, 2002, discussed above.

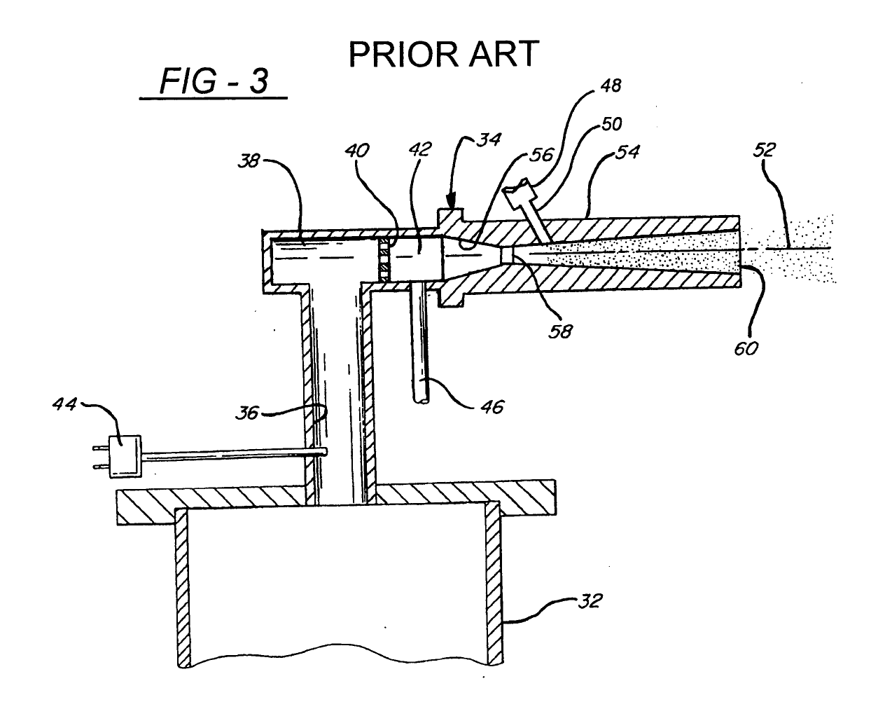

FIG. 3 is a cross sectional view of a prior art nozzle 34 for use with a low pressure powder feeder. The de Laval nozzle 54 is very similar to the high pressure one shown in FIG. 2 with the exception of the location of the supplemental inlet line 48 and the powder injector tube 50. In this prior art system the powder is injected after the throat 58, hence a low pressure feeder 30 can be used. The collimator 40 is the same as shown in FIG. 2.

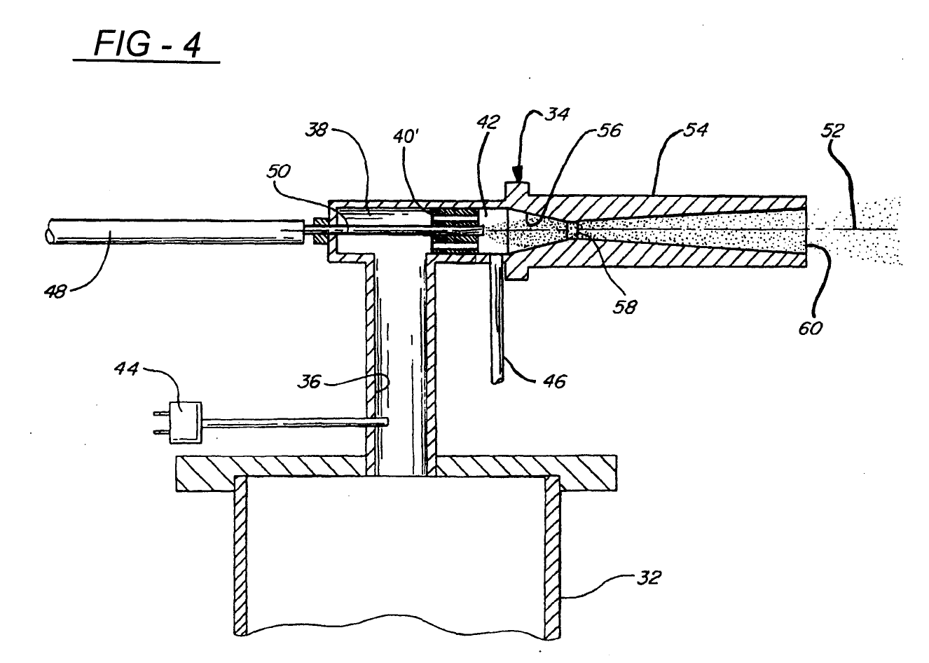

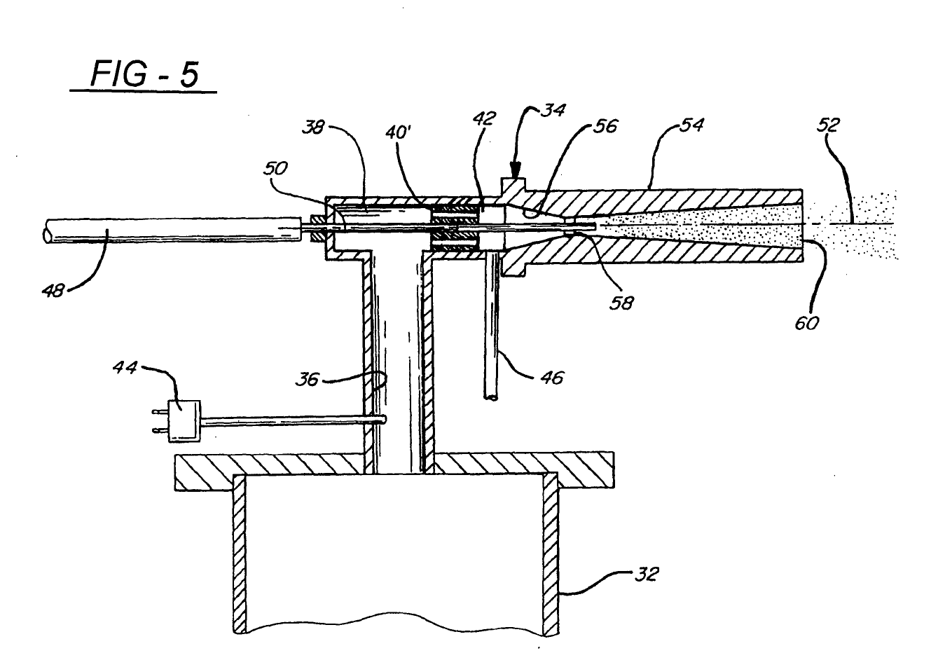

FIGS. 4 and 5 show a nozzle 54 and a gas collimator 40′ designed in accordance with the present invention. FIG. 4 shows a cross-sectional view of a high pressure nozzle 54 designed according to the present invention, while FIG. 5 is of a low pressure nozzle 54 designed according to the present invention. An end view of the collimator 40′ is shown in FIG. 8B. The collimator 40′ is much longer than the prior art collimator 40. Preferably the collimator 40′ has a length of from 10 to 30 millimeters, and more preferably from 25 to 30 millimeters. The collimator 40′ is preferably formed from a ceramic material so that it can withstand the temperature and pressures of the main gas. The collimator 40′ can, however, also be made from any metal or alloy capable of withstanding the main gas temperatures and pressures. The collimator 40′ has a central hole 114 for receiving the injector tube 50 and this central hole 114 is surrounded by a plurality of gas flow holes 116. In FIG. 8B the holes 116 are shown as hexagonal honeycomb shaped holes, however, other shapes such as circular shapes and other shapes will work as well. It is preferable that the hydraulic diameter for an individual hole 116 be from 0.5 to 5.0 millimeters. It is also preferable that the ratio of the hydraulic diameter of the holes 116 to a length of the collimator 40′ be from 1:5.0 to 1:50.0. Finally, it is preferable that the ratio of the total open space in a cross-sectional area of the collimator 40′ to the cross-sectional open area of the mixing chamber 42 be from 0.5:1.0 to 0.9:1.0.

The only differences between the nozzle 54 in FIG. 5 versus FIG. 4 are the length of the injector tube 50 and the diameter of the throat 58. In the low pressure nozzle 54 of FIG. 5 the injector tube 50 is longer and it extends into the diverging section of the nozzle 54. Because the injector tube 50 extends through the throat 58 the throat 58 must be wider. The throat 58 is widened such that a gap exists between the outside of the injector tube and the inside diameter of the throat 58. This gap provides a cross-sectional air flow area that is equivalent to that of FIG. 4 and so that it provides from 15 to 50 cubic feet per minute (cfm) of air flow, more preferably from 25 to 35 cfm.

The distance from the end of the throat 58 to the end of the injector tube 50 in the low pressure nozzle shown in FIG. 5 effects the deposition efficiency of the particles. Computer modeling indicates that it is preferable that the end of the injector tube 50 be located within the first ⅓ of the diverging section of the nozzle 54 to get maximal acceleration of the particles. Preferably the injector extends from 2 to 50 millimeters, and more preferably from 5 to 30 millimeters beyond the throat 58 into the diverging section of the nozzle 54. In an actual test two injector 50 lengths were compared. The first extended 12 millimeters beyond the throat 58 and the second extended 38 millimeters beyond the throat 58. For both nozzles 54 the particles were aluminum powder, feed rate was 1 gram per second, traverse speed was 2 inches per second, and the main gas temperature was 900° F. The substrate was aluminum. The nozzle 54 with the shorter injector tube 50 had a deposition of 325 grams per square meter and the longer injector tube 50 had a deposition of only 295 grams per square meter. Thus the shorter tube 50 was more efficient. In addition, it was found that the present invention eliminated the sawtooth edges found in use of the prior art low pressure nozzle. The edges of passes using the collimator 40′ of the present invention were clean and sharp like those found using high pressure kinetic spray systems. The present invention also eliminates the nozzle 54 sidewall erosion found in the prior art low pressure nozzle 54. Using the low pressure nozzle 54 of the present invention also permits the main gas pressure to be increased independently of the powder feeder 30 pressure. This permits an increase in the total mass flow rate which in turn increases deposition efficiency.

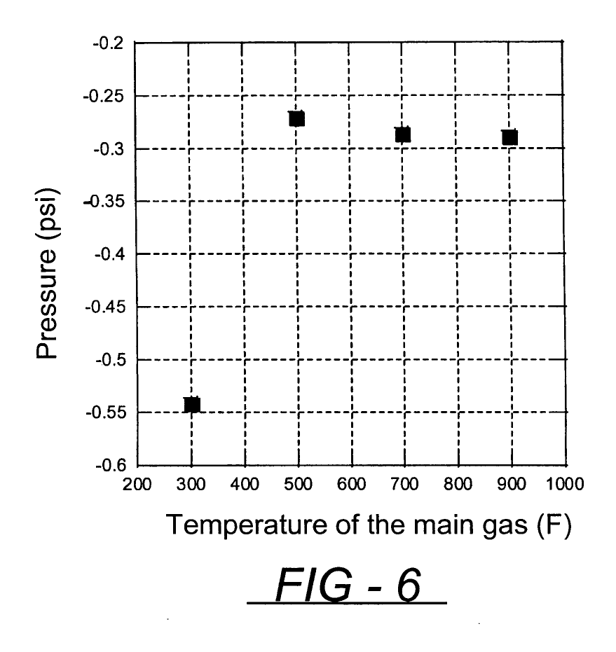

In FIG. 6 a graph is shown illustrating the pressures at the end of a low pressure nozzle 54 designed in accordance with the present invention and having an injector tube 50 that extends 25 millimeters beyond the throat 58 at various main gas temperatures. The main gas pressure was kept constant at 300 psi. While the measured pressures in FIG. 6 somewhat underestimate the true pressure at the end of the injector 50, the results demonstrate the existence of the low pressure region. This is why the injection method permits the use of low pressure powder feeders 30.

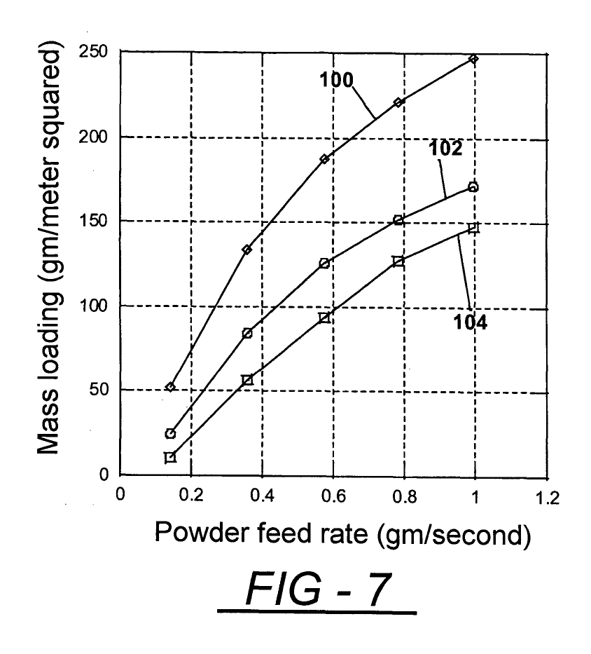

FIG. 7 shows the results of a series of comparative studies using the nozzles 54 shown in FIGS. 2, 3, and 5. The Y-axis is the particle loading per square meter on the substrate and the X-axis is the powder feed rate. For all nozzles 54 the main gas temperature was 800° F., the particles were an alloy of Al—Zn—Si (80-12-8) sprayed onto aluminum, the particle size was 53 to 106 microns, the traverse speed was 2 inches per second, and the main gas pressure was 300 psi. Reference line 100 was generated using a prior art high pressure nozzle 54 as shown in FIG. 2 using an injection pressure of 350 psi. Reference line 102 was generated using a low pressure nozzle 54 as shown in FIG. 5 designed according to the present invention. Reference line 104 was generated using a prior art low pressure nozzle 54 designed as shown in FIG. 3. The results show the new collimator 40′ in a low pressure nozzle 54 increases the amount of deposited particles on the substrate significantly at all feed rates versus the prior art low pressure nozzle 54 and collimator 40. The new low pressure nozzle 54 is still not as efficient as the prior art high pressure nozzle 54.

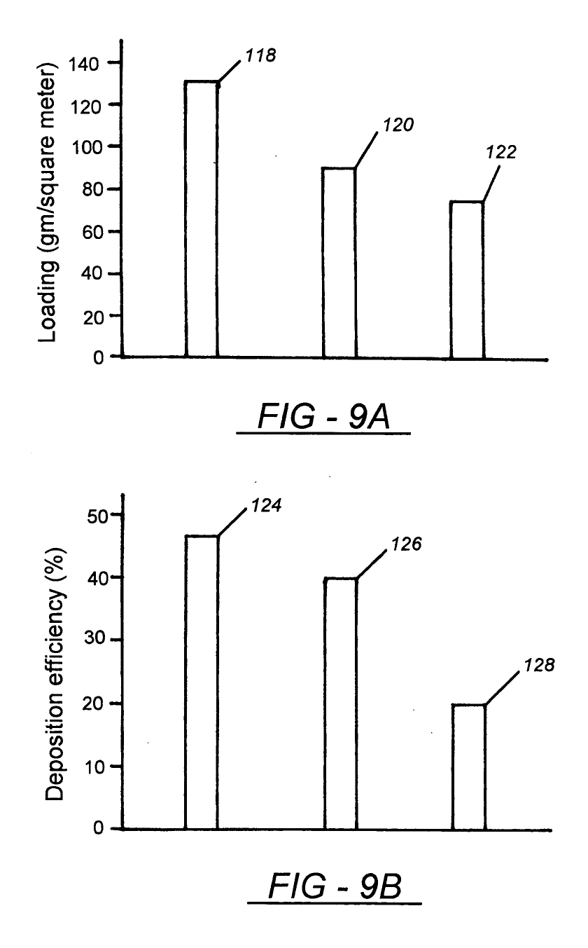

The collimator 40′ designed in accordance with the present invention also increased the efficiency of high pressure nozzles 54. In a comparison a nozzle 54 designed as shown in FIG. 2 was compared to a high pressure one designed according to the present invention as shown in FIG. 4. The results are shown in FIGS. 9A and 9B. In all of the tests the powder was an alloy of Al—Zn—Si (80-12-8) sprayed onto aluminum, the feed rates were kept constant at 0.5 grams per second, particle size 53 to 106 microns, the main gas pressure was 300 psi, the powder feeder 30 pressure was 350 psi., and the results are the average of 12 runs.

In FIG. 9A the loading per square meter of substrate is shown. Reference bar 118 represents the results from a high pressure powder feed nozzle 54 designed according to the present invention with a main gas temperature of 700° F. and a traverse speed of 4 inches per second. Reference bar 120 represents the results from the same nozzle 54 as reference bar 118 except the traverse speed was increased to 5 inches per second. Reference bar 122 represents the results from a prior art nozzle 54 designed in accordance with FIG. 2 with a prior art collimator 40, a main gas temperature of 800° F. and a traverse speed of 3 inches per second. The results demonstrate the benefits of the collimator 40′ designed according to the present invention. The collimator 40′ of the present invention permits for much higher depositions at higher traverse speeds and lower main gas temperatures. The ability to use a lower main gas temperature also results in less clogging of the throat 58.

In FIG. 9B the deposition efficiency is shown. Reference bar 124 represents the results from a high pressure nozzle 54 designed according to the present invention with a main gas temperature of 700° F. and a traverse speed of 4 inches per second. Reference bar 126 represents the results from the same nozzle 54 as reference bar 124 except the traverse speed was increased to 5 inches per second. Reference bar 128 represents the results from a prior art nozzle 54 designed in accordance with FIG. 2 with a prior art collimator 40, a main gas temperature of 800° F. and a traverse speed of 4 inches per second. The results demonstrate the benefits of the collimator 40′ designed according to the present invention. The collimator 40′ of the present invention permits for much higher deposition efficiencies at the same and at higher traverse speeds all with lower main gas temperatures. The deposition efficiency was over twice as high with the collimator 40′ at the same traverse speed and a lower main gas temperature, compare reference bars 124 and 128. Even when the traverse speed was increased to 5 inches per second, a 25% increase, the deposition efficiency was still twice as great with the prior art collimator 40, compare reference bars 126 and 128.

In the present invention it is preferred that the nozzle 34 be at an angle of from 0 to 45 degrees relative to a line drawn normal to the plane of the surface being coated, more preferably at an angle of from 15 to 25 degrees relative to the normal line. Preferably the work holder 18 moves the structure past being nozzle 34 at a traverse speed of from 0.25 to 6.0 inches per second and more preferably at a traverse speed of from 0.25 to 3.0 inches per second.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

1. A gas collimator for a kinetic spray nozzle comprising:
a collimator having a central hole surrounded by a plurality of gas flow holes and a length of from 10 to 30 millimeters; said gas flow holes having a hydraulic diameter of from 0.5 to 5.0 millimeters.

2. The gas collimator as recited in claim 1 wherein the ratio of said hydraulic diameter to said length is from 1:5 to 1:50.

3. The gas collimator as recited in claim 1 wherein said length of said collimator is from 25 to 30 millimeters.

4. The gas collimator as recited in claim 1 wherein said gas flow holes have a hexagonal shape.

5. A kinetic spray nozzle comprising:
a supersonic nozzle having a gas collimator located between a premix chamber and a mixing chamber; said mixing chamber located adjacent to a converging section of said nozzle; a throat located between said converging section and a diverging section of said nozzle; said collimator having a central hole surrounded by a plurality of gas flow holes and a length of from 10 to 30 millimeters; said gas flow holes having a hydraulic diameter of from 0.5 to 5.0 millimeters.

6. The kinetic spray nozzle as recited in claim 5 wherein the ratio of said hydraulic diameter to said length is from 1:5 to 1:50.

7. The kinetic spray nozzle as recited in claim 5 wherein said length of said collimator is from 25 to 30 millimeters.

8. The kinetic spray nozzle as recited in claim 5 wherein said gas flow holes have one of a hexagonal shape or a circular shape.

9. The kinetic spray nozzle as recited in claim 5 wherein the ratio of a total open area of a cross-section of said collimator to a cross-sectional open area of said mixing chamber is from 0.5:1 to 0.9:1.

10. The kinetic spray nozzle as recited in claim 5 further including an injector tube received in said central hole and extending through said collimator.

11. The kinetic spray nozzle as recited in claim 10 wherein said injector tube extends through said throat into said diverging section of said nozzle.

12. The kinetic spray nozzle as recited in a claim 11 wherein said injector tube extends up to one third of a length of said diverging section past said throat.

13. The kinetic spray nozzle as recited in a claim 11 wherein said injector tube extends from 2 to 50 millimeters past said throat.

14. The kinetic spray nozzle as recited in a claim 11 wherein said injector tube extends from 5 to 30 millimeters past said throat.

15. The kinetic spray nozzle as recited in claim 11 wherein a gap between said injector tube and an inside of said throat permits an air flow of from 15 to 50 cubic feet per minute through said gap.

16. The kinetic spray nozzle as recited in claim 11 wherein a gap between said injector tube and an inside of said throat permits an air flow of from 25 to 35 cubic feet per minute through said gap.

17. A method of applying a material via a kinetic spray process comprising:
a) providing a particle powder;
b) providing a converging diverging supersonic nozzle having a gas collimator having a central hole surrounded by a plurality of gas flow holes and a length of from 10 to 30 millimeters; the gas flow holes having a hydraulic diameter of from 0.5 to 5.0 millimeters;
c) directing a flow of a gas through the collimator and the nozzle, the gas having a temperature insufficient to cause melting of the particles in the nozzle; and
d) entraining the particles in the flow of the gas and accelerating the particles to a velocity sufficient to cause the particles to adhere to a substrate positioned opposite the nozzle.

18. The method as recited in claim 17 wherein step b) further comprises providing a collimator where the ratio of the hydraulic diameter to the length is from 1:5 to 1:50.

19. The method as recited in claim 17 wherein step b) further comprises providing a collimator where the length of the collimator is from 25 to 30 millimeters.

20. The method as recited in claim 17 wherein step b) further comprises providing a collimator having one of a hexagonal or a circular shaped gas flow holes.
